(19) United States
(12) Patent Application Publication
(10) Pub. No.: US 2026/0142731 A1
(43) Pub. Date: May 21, 2026

(54) TRANSMITTER, RECEIVER, AND QUANTUM KEY DISTRIBUTION SYSTEM

(71) Applicant: NEC Corporation, Tokyo (JP)

(72) Inventors: Tetsuo KAWAKAMI, Tokyo (JP); Hiroki KAWAHARA, Tokyo (JP); Toshihiko OKAMURA, Tokyo (JP); Seigo TAKAHASHI, Tokyo (JP)

(73) Assignee: NEC Corporation, Tokyo (JP)

(21) Appl. No.: 19/379,866

(22) Filed: Nov. 5, 2025

(30) Foreign Application Priority Data
Nov. 18, 2024 (JP) 2024-200926

(51) Int. Cl. H04B 10/70; H04J 14/06

(52) U.S. Cl. CPC H04B 10/70; H04J 14/06

(57) ABSTRACT

A transmitter includes a first light source that outputs first light, a first splitting unit that splits the first light into first polarized light of a first polarization and second polarized light of a second polarization, a first modulation unit that modulates the first polarized light based on a first random number, a second modulation unit that modulates the second polarized light based on data for bit position synchronization of the first random number, and a first polarization multiplexing unit that polarization-multiplexes the modulated first polarized light and the modulated second polarized light and transmits the polarization-multiplexed first polarization-multiplexed light to a receiver.

### INCORPORATION BY REFERENCE

This application is based upon and claims the benefit of priority from Japanese patent application No. 2024-200926, filed on Nov. 18, 2024, the disclosure of which is incorporated herein in its entirety by reference.

### TECHNICAL FIELD

The present disclosure relates to a transmitter, a receiver, a quantum key distribution system, and a method.

### BACKGROUND ART

In recent years, quantum cryptography has been studied as an encryption technique for ensuring security of communication. In quantum cryptography, quantum key distribution (QKD) enables secure sharing of a secret key between bases.

For quantum key distribution, discrete quantum key distribution (discrete variable QKD (DV-QKD)) in which quantum key distribution is performed using a photon detector and continuous quantum key distribution (continuous-variable quantum key distribution (CV-QKD) in which quantum key distribution is performed using coherent detection have been known. For example, in CV-QKD, a wavelength division multiplexing (WDM) technique used in general optical communication is applicable.

For example, JP 2017-050678 A is known as a related technique. In JP 2017-050678 A, optical signals for QKD and optical signals for other quantum cryptography (quantum noise stream cipher (QNSC)) are wavelength-multiplexed.

### SUMMARY

In CV-QKD, quantum key distribution (random number sharing) is performed by transmitting weak light (quantum light), in such a way that a receiver cannot know which bit a shared random number starts from in a bit string obtained from the weak light only by the weak light. Therefore, bit position synchronization for synchronizing bit positions at which shared random numbers start is required between a transmitter and the receiver by a transmission method different from the weak light. For example, in a case where an optical signal for bit position synchronization is transmitted by wavelength multiplexing as in a related technique such as JP 2017-050678 A, there is a problem that frequency utilization efficiency decreases.

In view of such a problem, an example object of the present disclosure is to provide a transmitter, a receiver, a quantum key distribution system, and a method capable of suppressing a decrease in frequency utilization efficiency.

A transmitter according to an example aspect of the present disclosure includes a first light source that outputs first light, a first splitting unit that splits the first light into first polarized light of a first polarization and second polarized light of a second polarization, a first modulation unit that modulates the first polarized light based on a first random number, a second modulation unit that modulates the second polarized light based on data for bit position synchronization of the first random number, and a first polarization multiplexing unit that polarization-multiplexes the modulated first polarized light and the modulated second polarized light and transmits the polarization-multiplexed first polarization-multiplexed light to a receiver.

A receiver according to an example aspect of the present disclosure includes a first photoelectric conversion unit that receives first polarization-multiplexed light from a transmitter and converts the received first polarization-multiplexed light into a first electric signal, a first polarization demodulation unit that polarization-demodulates the first electric signal into a first polarized signal of a first polarization and a second polarized signal of a second polarization, a first bit reading unit that reads a first bit string including a first random number from the first polarized signal, a second bit reading unit that reads a second bit string including data for bit position synchronization of the first random number from the second polarized signal, and a first bit position synchronization unit that performs bit position synchronization of the first random number included in the first bit string based on the data for the bit position synchronization included in the second bit string.

A quantum key distribution system according to an example aspect of the present disclosure includes a transmitter and a receiver, the transmitter including a first light source that outputs first light, a first splitting unit that splits the first light into first polarized light of a first polarization and second polarized light of a second polarization, a first modulation unit modulates the first polarized light based on a first random number, a second modulation unit that modulates the second polarized light based on data for bit position synchronization of the first random number, and a first polarization multiplexing unit that polarization-multiplexes the modulated first polarized light and the modulated second polarized light and transmits the polarization-multiplexed first polarization-multiplexed light to a receiver, and the receiver including a first photoelectric conversion unit that receives the first polarization-multiplexed light from the transmitter and converts the received first polarization-multiplexed light into a first electric signal, a first polarization demodulation unit that polarization-demodulates the first electric signal into a first polarized signal of a first polarization and a second polarized signal of a second polarization, a first bit reading unit that reads a first bit string including the first random number from the first polarized signal, a second bit reading unit that reads, from the second polarized signal, a second bit string including the data for bit position synchronization of the first random number, and a first bit position synchronization unit that performs bit position synchronization of the first random number included in the first bit string based on the data for bit position synchronization included in the second bit string.

A method according to an example aspect of the present disclosure is a method in a transmitter including splitting first light from a first light source into first polarized light of a first polarization and second polarized light of a second polarization, modulating the first polarized light based on a first random number, modulating the second polarized light based on data for bit position synchronization of the first random number, and polarization-multiplexing the modulated first polarized light and the modulated second polarized light and transmitting the polarization-multiplexed first polarization-multiplexed light to a receiver.

A method according to an example aspect of the present disclosure is a method in a receiver including receiving first polarization-multiplexed light from a transmitter and converting the received first polarization-multiplexed light into a first electric signal, polarization-demodulating the first electric signal into a first polarized signal of a first polarization and a second polarized signal of a second polarization, reading a first bit string including a first random number from the first polarized signal, reading a second bit string including data for bit position synchronization of the first random number from the second polarized signal, and performing bit position synchronization of the first random number included in the first bit string based on the data for bit position synchronization included in the second bit string.

According to the present disclosure, a decrease in frequency utilization efficiency can be suppressed.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a configuration diagram illustrating a configuration example of a quantum key distribution system according to a basic example of some example embodiments;

FIG. 2 is a frequency distribution diagram illustrating an example of a polarization-multiplexed signal in a quantum key distribution system according to the basic example of some example embodiments;

FIG. 3 is a configuration diagram illustrating a configuration example of an optical front end according to the basic example of some example embodiments;

FIG. 4 is a configuration diagram illustrating a wavelength configuration example in a quantum key distribution system according to the basic example of some example embodiments;

FIG. 5 is a wavelength distribution diagram illustrating the wavelength configuration example in the quantum key distribution system according to the basic example of some example embodiments;

FIG. 6 is a configuration diagram illustrating a configuration example of a transmitter according to some example embodiments;

FIG. 7 is a configuration diagram illustrating a configuration example of a receiver according to some example embodiments;

FIG. 8 is a configuration diagram illustrating a configuration example of a quantum key distribution system according to some example embodiments;

FIG. 9 is a frequency distribution diagram illustrating an example of a polarization-multiplexed signal in the quantum key distribution system according to some example embodiments;

FIG. 10 is a flowchart illustrating an operation example of the quantum key distribution system according to some example embodiments;

FIG. 11 is a diagram illustrating a specific example of clock synchronization according to some example embodiments;

FIG. 12 is a diagram illustrating a specific example of bit position synchronization according to some example embodiments;

FIG. 13 is a configuration diagram illustrating a wavelength configuration example in the quantum key distribution system according to some example embodiments;

FIG. 14 is a wavelength distribution diagram illustrating a wavelength configuration example in the quantum key distribution system according to some example embodiments;

FIG. 15 is a configuration diagram illustrating a configuration example of a transmitter according to some example embodiments;

FIG. 16 is a configuration diagram illustrating a configuration example of a receiver according to some example embodiments;

FIG. 17 is a configuration diagram illustrating the wavelength configuration example in a quantum key distribution system according to some example embodiments;

FIG. 18 is a wavelength distribution diagram illustrating a wavelength configuration example in the quantum key distribution system according to some example embodiments; and

FIG. 19 is a configuration diagram illustrating a configuration example of hardware of a computer according to some example embodiments.

### EXAMPLE EMBODIMENT

Hereinafter, example embodiments will be described with reference to the drawings. In the drawings, the same elements are denoted by the same reference signs, and redundant description will be omitted as necessary. Arrows illustrated in the drawings are illustrative examples, and do not limit the type or direction of a signal.

### Basic Example of Example Embodiment

First, in order to help understanding of a problem of example embodiments, a basic example that is a basis of some example embodiments will be described.

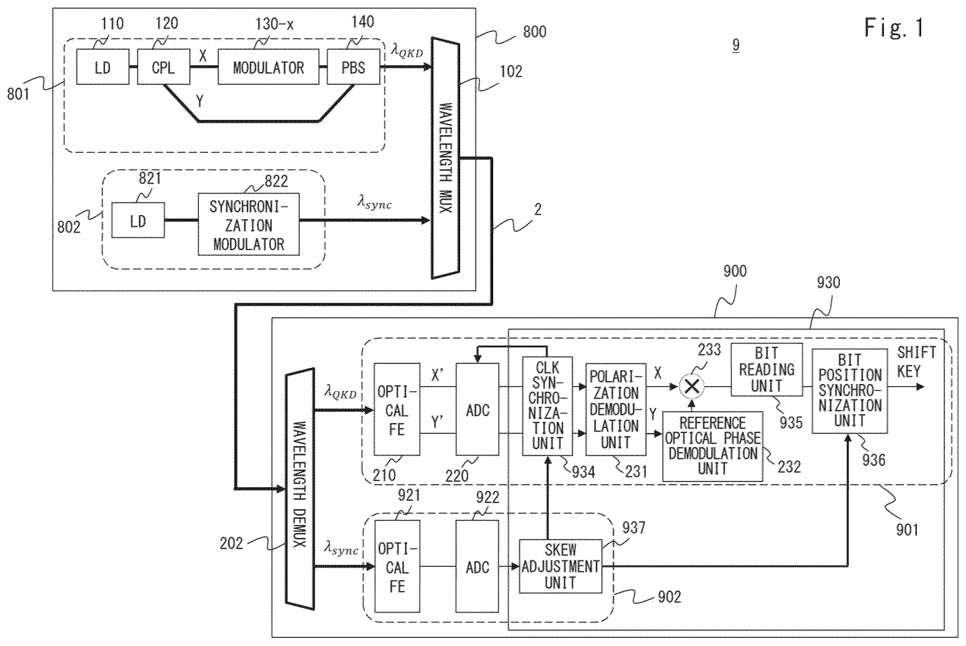

FIG. 1 illustrates a configuration example of a quantum key distribution system 9 according to a basic example of some example embodiments. In the example of FIG. 1, the quantum key distribution system 9 includes a transmitter 800 and a receiver 900. The quantum key distribution system 9 is a system that performs quantum key distribution by the transmitter 800 and the receiver 900. In quantum key distribution, a random number sequence serving as an element of an encryption key is transmitted using quantum light. This enables secure key sharing between the transmitter 800 and the receiver 900. The quantum key distribution system 9 performs quantum key distribution using light whose intensity is reduced to such an extent that quantum behavior can be confirmed. As a result, it is possible to quantum mechanically guarantee that the encryption key is not leaked, and to achieve high confidentiality.

In the example of FIG. 1, the quantum key distribution system 9 is a quantum key distribution system that performs quantum key distribution by CV-QKD. The transmitter 800 is a transmission device for CV-QKD. The receiver 900 is a reception device for CV-QKD.

In the example of FIG. 1, the transmitter 800 and the receiver 900 are communicably connected via an optical fiber 2. The transmitter 800 and the receiver 900 perform quantum key distribution using a quantum channel and a classical channel configured by a transmission path including the optical fiber 2.

The quantum channel is a communication channel for transmitting and receiving weak light (quantum light) transmitted from the transmitter 800 to the receiver 900. The weak light mentioned here is, for example, light that behaves in a quantum manner with optical power of about 1 photon/bit or less. The quantum channel is configured using, for example, the optical fiber 2. In the example of FIG. 1, wavelength multiplexing transmission is performed via the optical fiber 2, and a wavelength channel of a wavelength λ_{QKD} is used as a quantum channel.

A classical channel is a channel that is more reliable than the quantum channel. The high reliability of the communication channel means, for example, that a bit error rate (BER) is low. Hereinafter, for convenience of description, a communication channel without an error is assumed as a classical channel. The absence of the error mentioned herein may mean that all communication errors can be corrected by error correction or that all errors can be detected and retransmitted by error detection. A communication manner in the classical channel is not limited to a specific manner. For example, the classical channel may include the same optical fiber 2 as the quantum channel, or may include a transmission path different from the quantum channel.

Both notation of “transmission” of the transmitter 800 and notation of “reception” of the receiver 900 are for convenience of description, and data may be transmitted from the receiver 900 to the transmitter 800. In particular, the receiver 900 transmits information for performing processing in quantum key distribution to the transmitter 800 using the classical channel.

In the example of FIG. 1, the transmitter 800 includes a QKD signal transmission unit 801, a synchronization signal transmission unit 802, and a wavelength multiplexing unit (MUX) 102. The transmitter 800 may include a plurality of QKD signal transmission units 801 that transmit QKD signals of different wavelengths and a plurality of synchronization signal transmission units 802 that transmit synchronization signals of different wavelengths.

The QKD signal transmission unit 801 transmits a QKD signal including weak light (quantum light) for performing quantum key distribution by CV-QKD and reference light for demodulation assistance. In this example, the QKD signal is an optical signal having a wavelength λ_{QKD}. For example, the QKD signal transmission unit 801 modulates light to be transmitted by a modulation scheme similar to that of an optical transmitter used in coherent communication. The QKD signal transmission unit 801 modulates the weak light using random number data and basis data serving as a base of a key, and transmits the modulated weak light to the receiver 900 via a quantum channel (optical fiber 2).

In a case where the receiver used by an eavesdropper receives the quantum light from the transmitter 800, the basis data for decoding a code cannot be received before the code by the quantum light is received. Therefore, it is impossible to keep the quantum light in the state of the quantum light without leaving a trace from the quantum unreplicability theorem, and the receiver of the eavesdropper randomly selects one of the two bases and decodes the code by the quantum light stolen. In this case, the receiver used by the eavesdropper performs decoding using a basis different from the basis used by the transmitter 800 with a probability of 1/2, and cannot perform accurate decoding. The quantum state changes due to measurement of different bases, and eavesdropping can be detected, in such a way that eavesdropping cannot be performed.

The QKD signal transmission unit 801 includes a light source (laser diode (LD)) 110, an optical coupler (CPL) 120, a modulator 130-x, and a polarizing beam splitter (PBS) 140.

The light source 110 outputs light used for transmission of a QKD signal including quantum light and reference light. For example, the light source 110 is a laser diode that outputs laser light. The light source 110 outputs light having a wavelength λ_{QKD}.

The optical coupler 120 is a polarization separation unit that splits the light output from the light source 110 into X-polarized light and Y-polarized light. The optical coupler 120 outputs the split X-polarized light to the modulator 130-x and outputs the Y-polarized light to the polarizing beam splitter 140. In this example, the X-polarized light is modulated to generate weak light (quantum light), and the Y-polarized light is used as reference light. The Y-polarized light may be quantum light, or the X-polarized light may be reference light.

The modulator 130-x is a modulator that generates quantum light (weak light) to be transmitted. The modulator 130-x includes a phase modulator (PM). For example, the modulator 130-x is a DP-QPSK modulator that modulates light according to a dual polarization quadrature phase shift keying (DP-QPSK) modulation scheme. The modulator 130-x is not limited to the DP-QPSK modulation method, and may perform phase modulation by other modulation methods.

The modulator 130-x modulates the X-polarized light out of the light split by the optical coupler 120 to generate X-polarized signal light (quantum light). The modulator 130-x receives the random number data (shared random number) and the basis data (basis selection information), and modulates the X-polarized light split by the optical coupler 120 based on the random number data and the basis data. For example, with a combination of a phase of 0° and a phase of 180° as one basis and a combination of a phase of 90° and a phase of 270° as another basis, a QPSK signal is generated by the bits (Q value) of the basis data and the bits (I value) of the random number data.

The modulator 130-x further attenuates the modulated X-polarized signal light. For example, the modulator 130-x includes a variable optical attenuator (VOA). The modulator 130-x attenuates the modulated X-polarized signal light to a predetermined intensity, and outputs weak light (quantum light), which is the attenuated signal light, to the polarizing beam splitter 140. The modulator 130-x attenuates an optical power of the X-polarized signal light to a weak state of quantum behavior at about 1 photon/bit or less. This makes it possible to determine the presence or absence of eavesdropping by the principle of quantum mechanics.

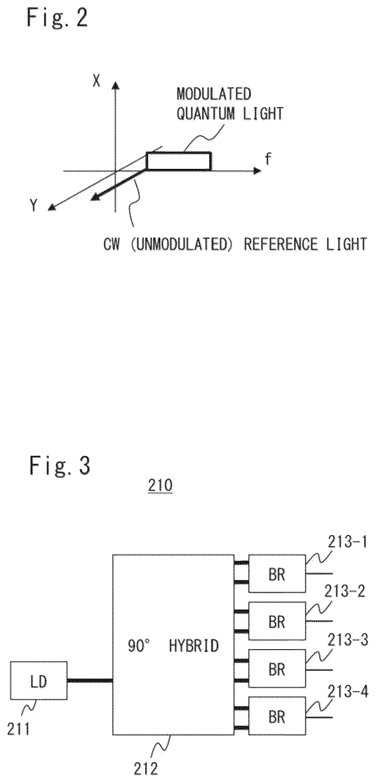

The polarizing beam splitter 140 is a polarization multiplexing unit that performs polarization multiplexing (polarization mixing) of the X-polarized signal light and the Y-polarized signal light. FIG. 2 illustrates an example of a polarization-multiplexed signal to be subjected to polarization multiplexing by the polarizing beam splitter 140 in the basic example. The polarizing beam splitter 140 polarization-multiplexes X-polarized signal light (modulated quantum light) modulated and attenuated by the modulator 130-x and Y-polarized signal light (unmodulated reference light) split from the optical coupler 120. The polarizing beam splitter 140 outputs a QKD signal of a wavelength λ_{QKD}, which is a polarization-multiplexed signal light that is polarization-multiplexed, to the wavelength multiplexing unit 102.

The synchronization signal transmission unit 802 transmits an optical signal (synchronization signal) for performing clock synchronization and bit position synchronization between the transmitter 800 and the receiver 900. In this example, the synchronization signal is an optical signal having a wavelength λ_{sync}.

The synchronization signal transmission unit 802 includes a light source (LD) 821 and a synchronization modulator 822. The light source 821 outputs light used for transmission of a synchronization signal. For example, the light source 821 is a laser diode that outputs laser light. The light source 821 outputs light having a wavelength λ_{sync}.

The synchronization modulator 822 is a modulator that generates a synchronization signal to be transmitted. The synchronization modulator 822 may perform modulation by a QPSK modulation method or may perform modulation by other modulation methods. The synchronization modulator 822 modulates the light output from the light source 821 based on data for clock synchronization and bit position synchronization. The synchronization modulator 822 outputs the modulated synchronization signal having the wavelength λ_{sync} to the wavelength multiplexing unit 102.

The wavelength multiplexing unit 102 performs wavelength multiplexing on the QKD signal having the wavelength λ_{QKD} and the synchronization signal having the wavelength λ_{sync}. The wavelength multiplexing unit 102 is an optical transmission unit that transmits the wavelength-multiplexed signal light subjected to wavelength multiplexing to the receiver 900 via the optical fiber 2.

In the example of FIG. 1, the receiver 900 includes a QKD signal reception unit 901, a synchronization signal reception unit 902, and a wavelength separation unit (DEMUX) 202. The receiver 900 may include a plurality of QKD signal reception units 901 that receive QKD signals of different wavelengths and a plurality of synchronization signal reception units 902 that receive synchronization signals of different wavelengths.

The wavelength separation unit 202 is an optical reception unit that receives wavelength-multiplexed signal light from the transmitter 800 via the optical fiber 2. The wavelength separation unit 202 separates the received wavelength-multiplexed signal light into an optical signal (QKD signal) having a wavelength λ_{QKD} and an optical signal (synchronization signal) having a wavelength λ_{sync}.

The synchronization signal reception unit 902 outputs a signal for clock synchronization and bit position synchronization based on the received synchronization signal. The synchronization signal reception unit 902 includes an optical front end (FE) 921 and an analog-to-digital converter (ADC) 922 and a skew adjustment unit 937.

The optical front end 921 photoelectrically converts the synchronization signal having the wavelength λ_{sync} received from the transmitter 800 and separated by the wavelength separation unit 202. The analog-to-digital converter 922 converts an analog electric signal photoelectrically converted by the optical front end 921 into a digital electric signal.

The skew adjustment unit 937 adjusts timings for clock synchronization and bit position synchronization for the QKD signal reception unit 901 based on the synchronization signal converted from analog-to-digital by the analog-to-digital converter 922, and outputs the adjusted synchronization signal to the QKD signal reception unit 901.

The QKD signal reception unit 901 receives a QKD signal including weak light (quantum light) and reference light for performing quantum key distribution by CV-QKD. In this example, the QKD signal is an optical signal having a wavelength λ_{QKD}. For example, the QKD signal reception unit 901 detects received light by coherent detection similar to the optical receiver used in coherent communication. The QKD signal reception unit 901 receives weak light from the transmitter 800 via the quantum channel (optical fiber 2), performs coherent detection on the received weak light, and generates a quantum key from a bit string obtained by the coherent detection.

The QKD signal reception unit 901 measures a state of an optical electric field from the weak light received via the quantum channel by coherent detection to generate an encryption key. In the coherent detection, signal light is filtered spatially, temporally, and wavelength-wise by interfering the signal light with local light, and a signal state is read out. As the local light here, laser light from a laser light source included in the receiver 900 is used.

In the case of DV-QKD which is another quantum key distribution method, the receiver generates an encryption key from the presence or absence of photons using a photon detector. On the other hand, in the case of CV-QKD, the system can be achieved by a general optical component, and can be achieved at a lower cost than DV-QKD using a photon detector. In CV-QKD, a quantum key distribution system in which general communication light and a transmission path coexist can be achieved by filtering using local light. In the coherent detection, the signal light can obtain a light amplification effect by causing local light having strong optical power to interfere with the signal light. Therefore, even in a weak state where the power of the signal light is 1 photon/bit or less, the signal light can be detected using a general photo detector (photodetector).

The QKD signal reception unit 901 includes an optical front end (FE) 210, an analog-to-digital converter (ADC) 220, a clock (CLK) synchronization unit 934, a polarization demodulation unit 231, a reference optical phase demodulation unit 232, a quantum optical phase correction unit 233, a bit reading unit 935, and a bit position synchronization unit 936.

Some of the functions of the QKD signal reception unit 901 and the synchronization signal reception unit 902 are performed by a digital signal processor (DSP) 930. For example, the digital signal processor 930 includes the clock synchronization unit 934, the polarization demodulation unit 231, the reference optical phase demodulation unit 232, the quantum optical phase correction unit 233, the bit reading unit 935, the bit position synchronization unit 936, and the skew adjustment unit 937. That is, these functions are achieved by digital signal processing by the digital signal processor 930. The digital signal processor 930 (QKD signal reception unit 901) may include functions necessary for quantum key generation, such as an error correction unit and a confidentiality enhancement unit.

The optical front end 210 photoelectrically converts the QKD signal having the wavelength λ_{QKD} received from the transmitter 800 and separated by the wavelength separation unit 202. The optical front end 210 coherently detects a QKD signal which is a polarization-multiplexed signal including weak light and reference light.

FIG. 3 illustrates a configuration example of the optical front end 210 according to the basic example. In the example of FIG. 3, the optical front end 210 includes a light source (LD) 211, a 90° hybrid 212, balance receivers (balanced detectors (BRs)) 213-1 to 213-4. The light source 211 outputs local light (local oscillation light) for coherent detection.

The 90° hybrid 212 and the balance receivers 213-1 to 213-4 coherently detect the received QKD signal including the weak light and the reference light using the local light output from the light source 211. The 90° hybrid 212 causes the local light output from the light source 211 and the received QKD signal to interfere with each other and reads out a quadrature-phase component. The 90° hybrid 212 projects a QKD signal which is received polarization-multiplexed signal light in phase with a Y-polarizations X′ and Y′ of the local light output from the light source 211, and generates signal light of an I component of X′ polarization, signal light of a Q component of X′ polarization, signal light of an I component of Y′ polarization, and signal light of a Q component of Y′ polarization.

The balance receivers 213-1 to 213-4 convert the quadrature phase component read by the 90° hybrid 212 into an electric signal. The balance receivers 213-1 to 213-4 detect and convert the signal light of the I component of the X′ polarization, the signal light of the Q component of the X′ polarization, the signal light of the I component of the Y′ polarization, and the signal light of the Q component of the Y′ polarization output from the 90° hybrid 212 into an analog electric signal, and output the converted analog electric signal of the I component of the X′ polarization, the analog electric signal of the Q component of the X′ polarization, the analog electric signal of the I component of the Y′ polarization, and the analog electric signal of the Q component of the Y′ polarization to the analog-to-digital converter 220. Hereinafter, detection of signal light by the balance receivers is also referred to as detection.

The analog-to-digital converter 220 converts a result of coherent detection of the received QKD signal into a digital electric signal. The analog-to-digital converter 220 quantizes (analog-to-digital converts) the analog electric signal of the I component of the X′ polarization, the analog electric signal of the Q component of the X′ polarization, the analog electric signal of the I component of the Y′ polarization, and the analog electric signal of the Q component of the Y′ polarization detected by the optical front end 210. The analog-to-digital converter 220 outputs the quantized I component digital electric signal of the X′ polarization, Q component digital electric signal of the X′ polarization, I component digital electric signal of the Y′ polarization, and Q component digital electric signal of the Y′ polarization to the clock synchronization unit 934 (digital signal processor 930).

The clock synchronization unit 934 extracts a clock timing based on the synchronization signal after skew adjustment by the skew adjustment unit 937, and outputs the extracted clock timing to the analog-to-digital converter 220. The analog-to-digital converter 220 performs sampling at the extracted clock timing and performs analog-to-digital conversion on the coherently detected signal.

The polarization demodulation unit 231 demodulates the received QKD signal to the polarization state before polarization multiplexing in the transmitter 800. That is, the polarization demodulation unit 231 polarization-separates the digital electric signal analog-to-digital converted by the analog-to-digital converter 220 into X-polarized and Y-polarized signals. For example, a known method can be used as the polarization separation processing by the polarization demodulation unit 231. The polarization demodulation unit 231 converts the I component digital electric signal of the X′ polarization, the Q component digital electric signal of the X′ polarization, the I component digital electric signal of the Y′ polarization, and the Q component digital electric signal of the Y′ polarization into X-polarization and Y-polarization signals, and generates the I component digital electric signal of the X-polarization and the Q component digital electric signal of the X-polarization after polarization separation (referred to as reception quantum optical signals), the I component digital electric signal of the Y-polarization, and the Q component digital electric signal of the Y-polarization (referred to as reception reference optical signals).

The reference optical phase demodulation unit 232 demodulates (corrects) the phase of the Y-polarized digital electric signal (reception reference optical signal) subjected to the polarization demodulation by the polarization demodulation unit 231. The reception reference optical signal has a phase variation due to a frequency and a phase difference between the light of the light source 110 of the transmitter 800 and the light of the light source 211 of the receiver 900. Therefore, the reference optical phase demodulation unit 232 tracks the phase variation due to the frequency and the phase difference between the light of the light source 110 of the transmitter 800 and the light of the light source 211 of the receiver 900 with respect to the reception reference optical signal, extracts the phase reference, and demodulates the original phase modulation value. The reference optical phase demodulation unit 232 outputs the phase correction value used for phase correction of the reception reference optical signal to the quantum optical phase correction unit 233.

The quantum optical phase correction unit 233 corrects the phase of the X-polarization digital electric signal (reception quantum optical signal) subjected to the polarization demodulation by the polarization demodulation unit 231. The quantum optical phase correction unit 233 reflects the phase correction value of the reception reference optical signal output from the reference optical phase demodulation unit 232 on the reception quantum optical signal. The reception quantum optical signal after reflection of the phase correction value of the reception reference optical signal is out of phase due to the phase difference between the quantum light (X-polarization) and the reference light (Y-polarization). Therefore, the quantum optical phase correction unit 233 corrects a phase shift due to a phase difference between the quantum light and the reference light with respect to the reception quantum optical signal after reflecting the phase correction value of the reception reference optical signal. The quantum optical phase correction unit 233 outputs the reception quantum optical signal after the phase correction to the bit reading unit 935.

The bit reading unit 935 performs hard decision on the reception quantum optical signal after the phase correction by the quantum optical phase correction unit 233 and reads the bit of 0 or 1 (quantum raw key). For example, the bit reading unit 935 may hard-decide a signal value after converting the QPSK signal into the BPSK signal by basis matching processing and read the bit. In the basis matching processing, a receiver receives basis data from a transmitter by using the classical channel, and performs the basis matching of the reception quantum optical signal obtained by the coherent detection.

For example, the bit reading unit 935 receives the basis data from the transmitter 800 through the classical channel, and rotates a phase of the reception quantum optical signal based on the basis data. The bit reading unit 935 performs hard decision on the reception quantum optical signal whose phase has been rotated, and outputs a bit string of 0 or 1.

The bit position synchronization unit 936 extracts a start position of a random number in the bit string based on the synchronization signal after skew adjustment by the skew adjustment unit 937. The bit position synchronization unit 936 outputs a bit string starting from the extracted start position as a random number sequence in the bit string read from the reception quantum optical signal by the bit reading unit 935. A random number sequence after bit position synchronization (after basis matching) is referred to as a shift key (selection key).

A quantum key is obtained by performing error correction and confidentiality enhancement on a generated shift key. The error correction processing and the confidentiality enhancement processing may be performed by the QKD signal reception unit 901 or may be performed outside the QKD signal reception unit 901. In the error correction, with the transmitter 100, a part of the bits for which the basis matching has been completed is disclosed on the classical channel to measure an error rate, and a part of the bits is further disclosed according to the measured error rate and used for correction, in such a way that the same bit string is shared between the transmitters and receivers.

In the confidentiality enhancement, noise and loss in a quantum channel are measured, a maximum amount of information obtained by an eavesdropper is estimated in a case where it is assumed that there is an eavesdropper, and a part of a bit string is randomly discarded such that the amount of information obtained by the eavesdropper becomes zero. That is, only the random number sequence having no possibility of eavesdropping is extracted from the bit string obtained by the error correction. The extracted random number sequence is used as a final key (quantum key). As a result, the transmitter 800 and the receiver 900 can share a random number sequence that is quantum mechanically guaranteed not to be eavesdropped.

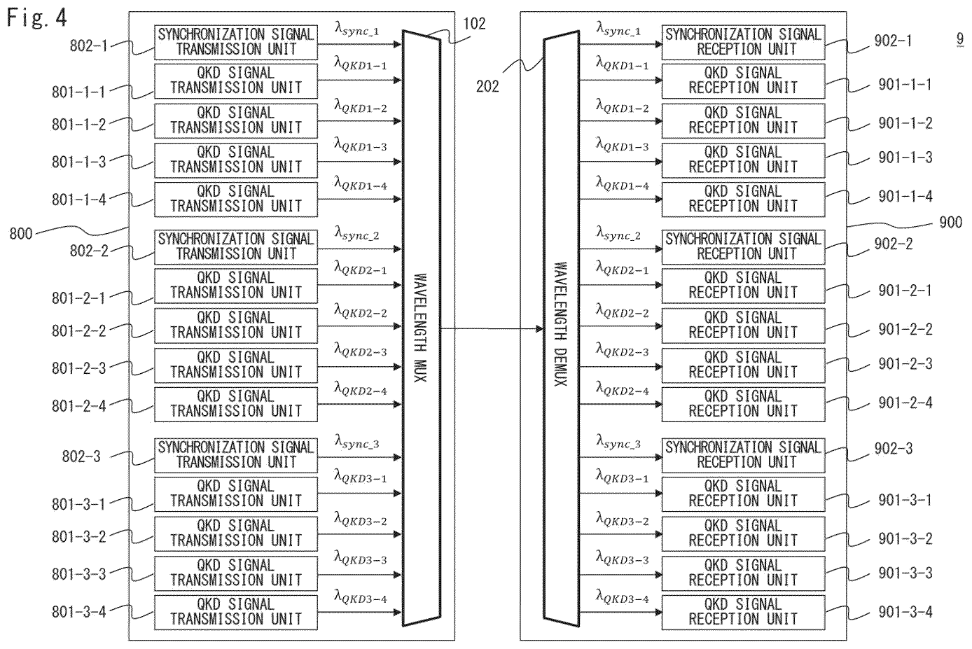

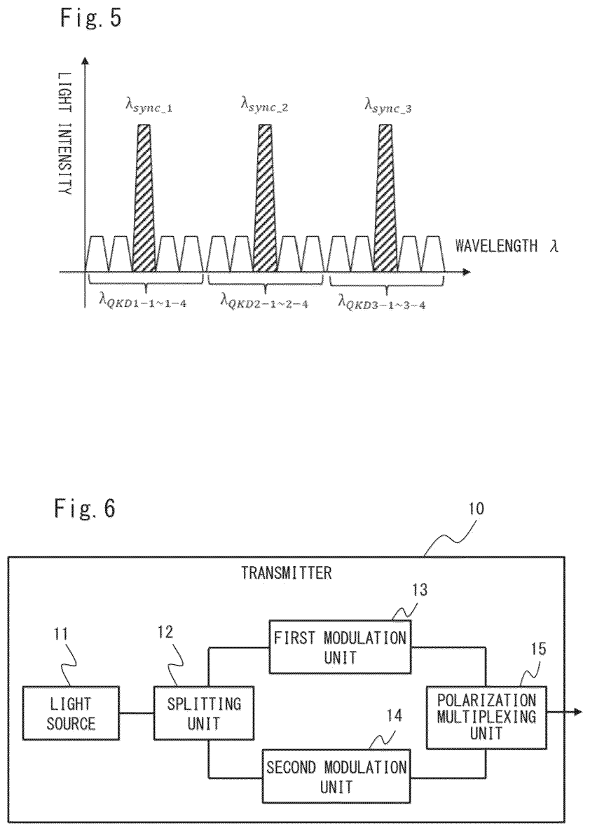

A wavelength configuration example in the quantum key distribution system 9 according to the basic example will be described with reference to FIGS. 4 and 5. Clock synchronization and bit position synchronization of a plurality of QKD signals can be performed using one synchronization signal. In the examples of FIGS. 4 and 5, clock synchronization and bit position synchronization of QKD signals of four wavelengths λ_{QKD} are performed using a synchronization signal of one wavelength λ_{sync}.

In the example of FIG. 4, the transmitter 800 includes a synchronization signal transmission unit 802-1 that transmits a synchronization signal having a wavelength λ_{sync_1}, QKD signal transmission units 801-1-1 to 801-1-4 that respectively transmit QKD signals having wavelengths λ_{QKD1-1} to λ_{QKD1-4} synchronized with the synchronization signal having the wavelength λ_{sync_1}, a synchronization signal transmission unit 802-2 that transmits a synchronization signal having a wavelength λ_{sync_2}, QKD signal transmission units 801-2-1 to 801-2-4 that respectively transmit QKD signals having wavelengths λ_{QKD2-1} to λ_{QKD2-4} synchronized with the synchronization signal having the wavelength λ_{sync_2}, a synchronization signal transmission unit 802-3 that transmits a synchronization signal having a wavelength λ_{sync_3}, and QKD signal transmission units 801-3-1 to 801-3-4 that respectively transmit QKD signals having wavelengths λ_{QKD3-1} to λ_{QKD3-4} synchronized with the synchronization signal having the wavelength λ_{sync_3}.

The wavelength multiplexing unit 102 performs wavelength multiplexing on the optical signals (synchronization signals) of the wavelengths λ_{sync_1}, λ_{sync_2}, and λ_{sync_3} and the optical signals (QKD signals) of the wavelengths λ_{QKD1-1} to λ_{QKD1-4}, λ_{QKD2-1} to λ_{QKD2-4}, and λ_{QKD3-1} to λ_{QKD3-4}.

In the receiver 900, the wavelength separation unit 202 separates the wavelength-multiplexed optical signal into optical signals (synchronization signals) of wavelengths λ_{sync_1}, λ_{sync_2}, and λ_{sync_3}, and optical signals (QKD signals) of wavelengths λ_{QKD1-1} to λ_{QKD1-4}, wavelengths λ_{QKD2-1} to λ_{QKD2-4}, and wavelengths λ_{QKD3-1} to λ_{QKD3-4}.

The receiver 900 includes a synchronization signal reception unit 902-1 that receives a synchronization signal having a wavelength λ_{sync_1}, QKD signal reception units 901-1-1 to 901-1-4 that respectively receive QKD signals having wavelengths λ_{QKD1-1} to λ_{QKD1-4} synchronized with the synchronization signal having the wavelength λ_{sync_1}, a synchronization signal reception unit 902-2 that receives a synchronization signal having a wavelength λ_{sync_2}, QKD signal reception units 901-2-1 to 901-2-4 that respectively receive QKD signals having wavelengths λ_{QKD2-1} to λ_{QKD2-4} synchronized with the synchronization signal having the wavelength λ_{sync_2}, a synchronization signal reception unit 902-3 that receives a synchronization signal having a wavelength λ_{sync_3}, and QKD signal reception units 901-3-1 to 901-3-4 that respectively receive QKD signals having wavelengths λ_{QKD3-1} to λ_{QKD3-4} synchronized with the synchronization signal having the wavelength λ_{sync_3}.

In this case, as in FIG. 5, one of the five wavelengths is used for the synchronization signal. For example, for clock synchronization and bit position synchronization of QKD signals of the wavelengths λ_{QKD1-1} to λ_{QKD1-4}, a synchronization signal of the central wavelength λ_{sync_1} of the wavelengths λ_{QKD1-1} to λ_{QKD1-4} is used. For clock synchronization and bit position synchronization of the QKD signals of the wavelengths λ_{QKD2-1} to λ_{QKD2-4}, a synchronization signal of the central wavelength λ_{sync_2} of the wavelengths λ_{QKD2-1} to λ_{QKD2-4} is used. For clock synchronization and bit position synchronization of the QKD signals of the wavelengths λ_{QKD3-1} to λ_{QKD3-4}, a synchronization signal of the central wavelength λ_{sync_3} of the wavelengths λ_{QKD3-1} to λ_{QKD3-4} is used.

As described above, in CV-QKD, transmission of weak coherent light is performed, in such a way that random number sharing is performed without allowing eavesdropping between two distant parties. In CV-QKD in which the intensity of transmission light is weak, a different-wavelength optical signal is essential for bit position synchronization. For example, in the basic example, as illustrated in FIG. 5, a synchronization signal having a wavelength λ_{sync} is required. Therefore, the frequency utilization efficiency of the quantum key distribution system is reduced. A major feature of CV-QKD is that it is wavelength-multiplexable, and thus this problem of reducing frequency utilization of CV-QKD systems is a very important issue.

### First Example Embodiment

Next, a first example embodiment will be described. In the present example embodiment, outlines of some example embodiments will be described.

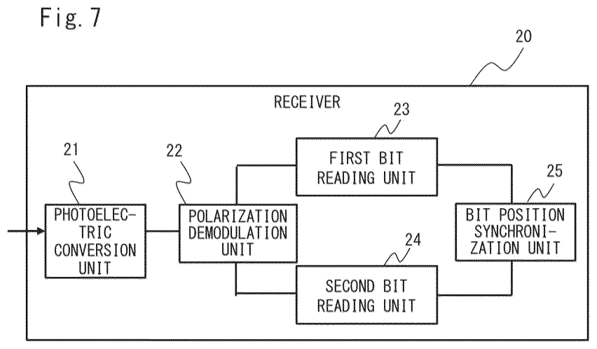

FIG. 6 illustrates an example configuration of a transmitter 10 according to some example embodiments. FIG. 7 illustrates an example configuration of a receiver 20 according to some example embodiments. For example, the transmitter 10 and the receiver 20 are communicably connected via an optical transmission line to constitute a quantum key distribution system. The quantum key distribution system is also a system that shares a random number serving as a base of a quantum key (secret key). The transmitter 10 is a transmitter for QKD (QKD transmitter), and the receiver 20 is a receiver for QKD (QKD receiver). In this example, QKD is CV-QKD.

In the example of FIG. 6, the transmitter 10 includes a light source 11, a splitting unit 12, a first modulation unit 13, a second modulation unit 14, and a polarization multiplexing unit 15.

The light source (for example, first light source) 11 outputs light (for example, first light). The splitting unit (for example, a first splitting unit) 12 splits the light output from the light source 11 into first polarized light of a first polarization and second polarized light of a second polarization. The first polarization may be one of the X-polarization and the Y-polarization, and the second polarization may be the other of the X-polarization and the Y-polarization.

The first modulation unit 13 modulates the first polarized light split by the splitting unit 12 based on a random number (for example, a first random number). The second modulation unit 14 modulates the second polarized light split by the splitting unit 12 based on the data for bit position synchronization of the random number. The data for bit position synchronization is data for synchronizing the bit position of the random number used for modulation by the first modulation unit 13 between the transmitter 10 and the receiver 20. For example, the data for bit position synchronization indicates a start position of a random number in a bit string modulated (transmitted) by the first modulation unit 13. The second polarized light modulated by the second modulation unit 14 may indicate a clock timing at which the first polarized light modulated by the first modulation unit 13 is transmitted. The second polarized light modulated by the second modulation unit 14 may be reference light for phase demodulation of the first polarized light modulated by the first modulation unit 13.

The polarization multiplexing unit 15 polarization-multiplexes the modulated first polarized light and the modulated second polarized light, and transmits the polarization-multiplexed polarized light (for example, the first polarization-multiplexed light) to the receiver 20. The transmitter 10 may include a wavelength multiplexing unit that performs wavelength multiplexing on the polarization-multiplexed light polarization-multiplexed by the polarization multiplexing unit 15 and transmits the wavelength-multiplexed light to the receiver 20.

In the example of FIG. 7, the receiver 20 includes a photoelectric conversion unit 21, a polarization demodulation unit 22, a first bit reading unit 23, a second bit reading unit 24, and a bit position synchronization unit 25.

The photoelectric conversion unit (for example, a first photoelectric conversion unit) 21 receives the polarization-multiplexed light from the transmitter 10, and converts the received polarization-multiplexed light into an electric signal (for example, a first electric signal). For example, the photoelectric conversion unit 21 may coherently detect the received polarization-multiplexed light and convert the received polarization-multiplexed light into an electric signal.

The receiver 20 may include a wavelength separation unit that receives the wavelength-multiplexed light from the transmitter 10 and wavelength-separates the polarization-multiplexed light from the received wavelength-multiplexed light. In this case, the photoelectric conversion unit 21 photoelectrically converts the wavelength-separated polarization-multiplexed light. The receiver 20 may include an analog-to-digital conversion unit that performs analog-to-digital conversion of the photoelectrically converted electric signal, and a clock synchronization unit that extracts a clock timing based on the analog-to-digital converted digital signal. In this case, the analog-to-digital conversion unit may perform analog-to-digital conversion based on the extracted clock timing.

The polarization demodulation unit (for example, a first polarization demodulation unit) 22 polarization-demodulates the electric signal converted by the photoelectric conversion unit 21 into a first polarized signal of a first polarization and a second polarized signal of a second polarization. The polarization demodulation unit 22 demodulates the signals into signals of the same polarization as the first polarization and the second polarization subjected to polarization multiplexing in the transmitter 10.

The receiver 20 may include a phase demodulation unit that demodulates the phases of the first polarized signal and the second polarized signal based on the first polarized signal and the second polarized signal subjected to the polarization demodulation by the polarization demodulation unit 22. For example, the phase demodulation unit may demodulate a phase of the second polarized signal and demodulate a phase of the first polarized signal based on the demodulated phase.

The first bit reading unit 23 reads a first bit string including a random number from the first polarized signal subjected to polarization demodulation by the polarization demodulation unit 22. The second bit reading unit 24 reads a second bit string including data for bit position synchronization of a random number from the second polarized signal subjected to the polarization demodulation by the polarization demodulation unit 22.

The bit position synchronization unit (for example, the first bit position synchronization unit) 25 performs bit position synchronization of the random number included in the first bit string read by the first bit reading unit 23 based on the data for bit position synchronization included in the second bit string read by the second bit reading unit 24. For example, the bit position synchronization unit 25 may perform bit position synchronization based on a start position of a random number indicated by data for bit position synchronization. That is, the bit position synchronization unit 25 outputs data starting from a bit associated with a start position indicated by the data for bit position synchronization in the first bit string as a random number shared with the transmitter 10.

As described above, in the present example embodiment, the optical signal of the first polarization modulated by the random number and the optical signal of the second polarization modulated by the data for bit position synchronization are polarization-multiplexed and transmitted, whereby the bit position synchronization is performed between the transmitter and the receiver. As a result, since a wavelength for bit position synchronization is unnecessary, a decrease in frequency utilization efficiency can be suppressed.

In the following example embodiments, specific examples of the first example embodiment will be described.

### Second Example Embodiment

Next, a second example embodiment will be described. In the present example embodiment, data for bit position synchronization can be transmitted at a wavelength for QKD with respect to the configuration of the basic example. Therefore, the present example embodiment can be implemented in combination with the basic example, and each configuration described in the basic example may be appropriately used.

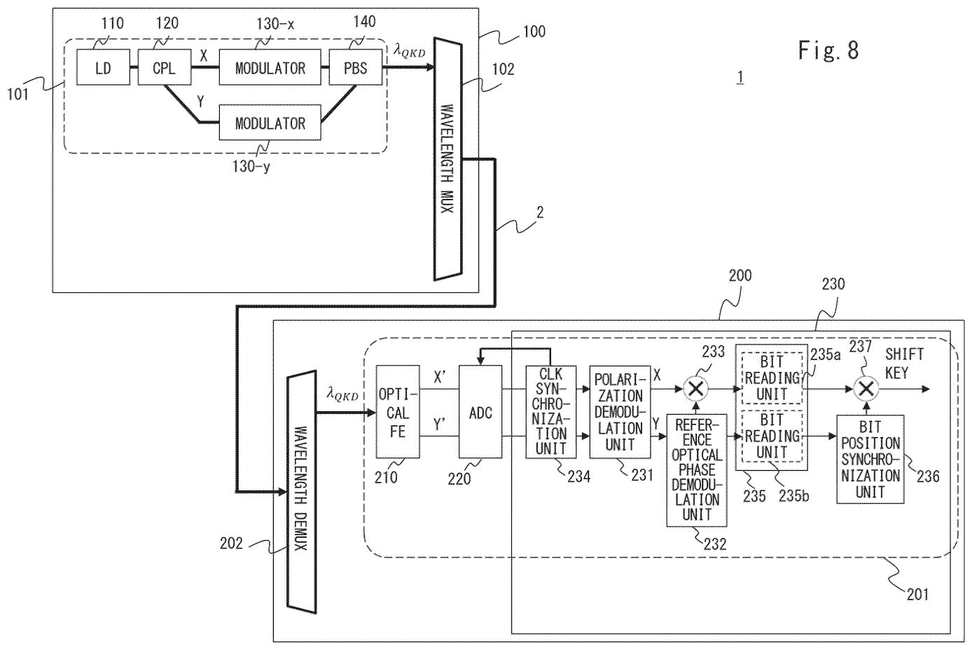

FIG. 8 illustrates a configuration example of a quantum key distribution system 1 according to some example embodiments. Similarly to the basic example of FIG. 1, the quantum key distribution system 1 is a quantum key distribution system that performs quantum key distribution by CV-QKD.

In the example of FIG. 8, the quantum key distribution system 1 includes a transmitter 100 and a receiver 200. Similarly to the basic example of FIG. 1, the transmitter 100 is a transmission device for QKD (quantum key distribution device on the transmission side) that performs quantum key distribution by CV-QKD, and the receiver 200 is a reception device for QKD (quantum key distribution device on the reception side) that performs quantum key distribution by CV-QKD. Similarly to the basic example of FIG. 1, the transmitter 100 and the receiver 200 are communicably connected via the optical fiber 2.

In the example of FIG. 8, the transmitter 100 includes a QKD signal transmission unit 101 and a wavelength multiplexing unit (MUX) 102. The transmitter 100 may include a plurality of QKD signal transmission units 101 that transmit QKD signals of different wavelengths.

Similarly to the basic example of FIG. 1, the QKD signal transmission unit 101 polarization-multiplexes weak light (quantum light) and reference light for performing quantum key distribution by CV-QKD, and transmits a polarization-multiplexed QKD signal having a wavelength λ_{QKD} to the receiver 200 via the optical fiber 2 (quantum channel).

In the example of FIG. 8, similarly to FIG. 1, the QKD signal transmission unit 101 includes a light source (LD) 110, an optical coupler (CPL) 120, a modulator 130-x, and a polarization beam splitter (PBS) 140, and further includes a modulator 130-y. Here, a configuration different from that in FIG. 1 will be mainly described.

The modulator 130-y is a modulator that generates reference light to be transmitted. For example, the modulator 130-y may be a phase modulator. Similarly to the modulator 130-x, the modulator 130-y may be a DP-QPSK modulation device or a modulator of another modulation scheme. The modulator 130-y modulates the Y-polarized light out of the light split by the optical coupler 120 to generate Y-polarized signal light (reference light), and outputs the modulated Y-polarized signal light to the polarizing beam splitter 140.

The modulator 130-y receives the data for bit position synchronization and modulates the Y-polarized light split by the optical coupler 120 based on the data for bit position synchronization. The data for the bit position synchronization is data indicating a start position of a random number transmitted by quantum light, and is shared between the transmitter 100 and the receiver 200 in advance. A start position of the random number modulated and transmitted by the modulator 130-x is synchronized with the start position indicated by the data for bit position synchronization modulated and transmitted by the modulator 130-y. The data for bit position synchronization may be any data as long as it can indicate the start position of the random number. The data for bit position synchronization may be a bit string having a predetermined length, for example, 2 to the power of 15. For example, with a length of about several bits, it is not possible to perform synchronization in a case where there is a difference in timing across data of the length, and thus, it is preferable to use bits of a predetermined length or more.

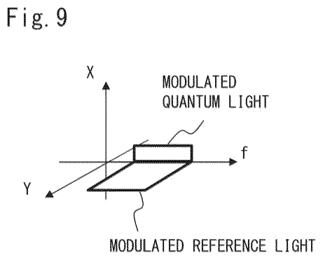

The polarizing beam splitter 140 polarization-multiplexes the modulated X-polarized signal light and the modulated Y-polarized signal light. FIG. 9 illustrates an example of a polarization-multiplexed signal to be subjected to polarization multiplexing by the polarizing beam splitter 140 in some example embodiments. The polarizing beam splitter 140 polarization-multiplexes X-polarized signal light (modulated quantum light) modulated and attenuated by the modulator 130-x and Y-polarized signal light (modulated reference light) modulated by the modulator 130-y. The polarizing beam splitter 140 outputs a QKD signal of a wavelength λ_{QKD}, which is polarization-multiplexed signal light that is polarization-multiplexed, to the wavelength multiplexing unit 102.

Similarly to the basic example, the wavelength multiplexing unit 102 performs wavelength multiplexing on the QKD signal of the wavelength λ_{QKD} generated by the QKD signal transmission unit 101. In a case where the plurality of QKD signal transmission units 101 generates a plurality of QKD signals having different wavelengths λ_{QKD}, the wavelength multiplexing unit 102 performs wavelength multiplexing on the QKD signals having the plurality of wavelengths λ_{QKD}. The wavelength multiplexing unit 102 transmits the wavelength-multiplexed signal light subjected to wavelength multiplexing to the receiver 200 via the optical fiber 2.

In the example of FIG. 8, the receiver 200 includes a QKD signal reception unit 201 and a wavelength separation unit (DEMUX) 202. The receiver 200 may include a plurality of QKD signal reception unit 201 that receive QKD signals of different wavelengths.

Similarly to the basic example, the wavelength separation unit 202 receives the wavelength-multiplexed signal light from the transmitter 100 via the optical fiber 2, and separates the optical signal (QKD signal) having the wavelength λ_{QKD} from the received wavelength-multiplexed signal light. In a case where the wavelength-multiplexed signal includes a plurality of QKD signals having different wavelengths λ_{QKD}, the wavelength separation unit 202 separates the wavelength-multiplexed signal into QKD signals having a plurality of wavelengths λ_{QKD}.

Similarly to the basic example of FIG. 1, the QKD signal reception unit 201 receives weak light (quantum light) and reference light for performing quantum key distribution by CV-QKD. Similarly to FIG. 1, the QKD signal reception unit 201 includes an optical front end (FE) 210, an analog-to-digital converter (ADC) 220, a polarization demodulation unit 231, a reference optical phase demodulation unit 232, and a quantum optical phase correction unit 233, and further includes a clock (CLK) synchronization unit 234, a bit reading unit 235, a bit position synchronization unit 236, and a shift key output unit 237. For example, the polarization demodulation unit 231, the reference optical phase demodulation unit 232, the quantum optical phase correction unit 233, the clock synchronization unit 234, the bit reading unit 235, the bit position synchronization unit 236, and the shift key output unit 237 are configured by a digital signal processor 230. Here, a configuration different from that in FIG. 1 will be mainly described.

The clock synchronization unit 234 extracts a clock timing based on the digital electric signal of the Y polarized light component (reference light component) of the optical signal before polarization demodulation after quantization converted by the analog-to-digital converter 220, and outputs the extracted clock timing to the analog-to-digital converter 220. The clock synchronization unit 234 may extract the clock timing based on the digital electric signal of the X-polarized light component (quantum light component) of the optical signal before the polarization demodulation. Similarly to the basic example, the analog-to-digital converter 220 performs sampling at the extracted clock timing and performs analog-to-digital conversion on the signal coherently detected. The analog-to-digital converter 220 may perform clock extraction processing similar to that of the clock synchronization unit 234.

The bit reading unit 235 reads bits from the reception quantum optical signal after phase correction by the quantum optical phase correction unit 233, and reads bits from the reception reference optical signal after phase demodulation by the reference optical phase demodulation unit 232. For example, the bit reading unit 235 includes a bit reading unit 235a (for example, a first bit reading unit) that reads bits from the reception quantum optical signal after phase correction, and a bit reading unit 235b (for example, a second bit reading unit) that reads bits from the reception reference optical signal after phase demodulation.

The bit reading unit 235a is similar to the bit reading unit 935 of the basic example. For example, the bit reading unit 235a performs hard decision on the reception quantum optical signal after the phase correction to generate a bit string of 0 or 1 (referred to as a quantum optical bit string). The bit reading unit 235a may perform the basis matching processing using the classical channel and read the quantum optical bit string. The bit reading unit 235b performs hard decision on the reception reference optical signal after the phase demodulation, and generates a bit string of 0 or 1 (referred to as a reference light bit string).

The bit position synchronization unit 236 extracts data for bit position synchronization from the reference light bit string read from the reception reference optical signal after the phase demodulation by the bit reading unit 235b, and specifies the start position of the random number by the data for bit position synchronization. The bit position synchronization unit 236 outputs the specified start position of the random number to the shift key output unit 237.

The shift key output unit 237 outputs, as a shift key, a bit string starting from the start position of the random number specified by the bit position synchronization unit 236 among the quantum optical bit strings read from the reception quantum optical signal after the phase correction by the bit reading unit 235a.

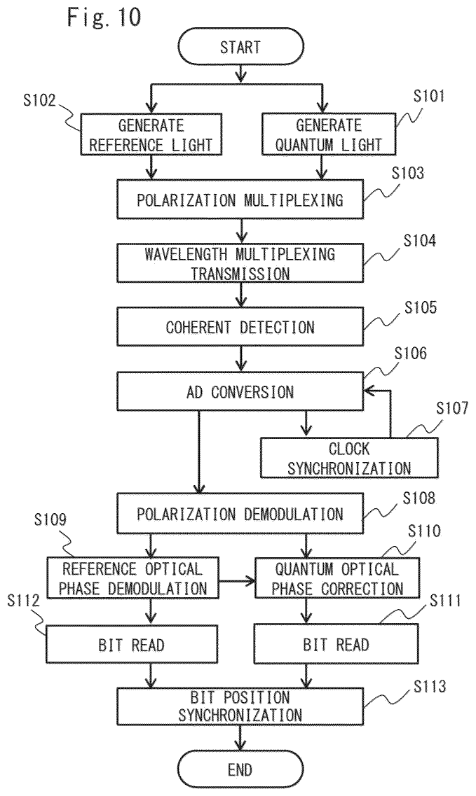

FIG. 10 illustrates an operation example of the quantum key distribution system 1 according to some example embodiments. In the example of FIG. 10, the transmitter 100 generates quantum light (S101) and generates reference light (S102). The transmitter 100 generates (modulates) quantum light by random numbers and generates (modulates) reference light by data for bit position synchronization in synchronization with each other.

The modulator 130-x modulates the X-polarized light output from the light source 110 and split by the optical coupler 120 to generate X-polarized quantum light (weak light). The modulator 130-x modulates the X-polarized light split by the optical coupler 120 based on the random number data and the basis data (basis selection information), and attenuates the power of the modulated light to obtain weak light.

The modulator 130-y modulates the Y-polarized light output from the light source 110 and split by the optical coupler 120 to generate the Y-polarized reference light. The modulator 130-y modulates the Y-polarized light split by the optical coupler 120 based on the data for bit position synchronization in synchronization with the modulation by the modulator 130-x.

Subsequently, the transmitter 100 polarization-multiplexes the generated quantum light and reference light (S103). The polarizing beam splitter 140 polarization-multiplexes X-polarized quantum light modulated and attenuated by the modulator 130-x and Y-polarized reference light modulated by the modulator 130-y, and generates a QKD signal having a wavelength λ_{QKD}, which is polarization-multiplexed signal light that is polarization-multiplexed.

Subsequently, the transmitter 100 transmits the wavelength-multiplexed signal light subjected to wavelength multiplexing (S104). The wavelength multiplexing unit 102 performs wavelength multiplexing on the QKD signal having the wavelength λ_{QKD} generated by the QKD signal transmission unit 101, and transmits the wavelength-multiplexed signal light obtained by the wavelength multiplexing to the receiver 200 via the optical fiber 2.

Subsequently, the receiver 200 performs coherent detection on the transmitted wavelength-multiplexed signal light (S105). The wavelength separation unit 202 receives the wavelength-multiplexed signal light from the transmitter 800 via the optical fiber 2 and demultiplexes the received wavelength-multiplexed signal light into a QKD signal having a wavelength λ_{QKD}. The optical front end 210 coherently detects the separated QKD signal (polarization-multiplexed signal) having the wavelength λ_{QKD} using the local light output from the light source 211. The optical front end 210 interferes the local light output from the light source 211 with the received QKD signal to read out the quadrature phase component, and converts the read signal light of the I component of the X′ polarization, the signal light of the Q component of the X′ polarization, the signal light of the I component of the Y′ polarization, and the signal light of the Q component of the Y′ polarization into electric signals.

Subsequently, the receiver 200 performs analog-to-digital conversion on the result of the coherent detection (S106) and performs clock synchronization (S107). The analog-to-digital converter 220 converts the analog electric signal of the I component of the X′ polarization, the analog electric signal of the Q component of the X′ polarization, the analog electric signal of the I component of the Y′ polarization, and the analog electric signal of the Q component of the Y′ polarization, all of which are coherently detected, into digital electric signals.

For example, the clock synchronization unit 234 extracts the clock timing based on the analog-to-digital converted digital electric signal of the Y polarized light component (reference light component) of the optical signal before polarization demodulation.

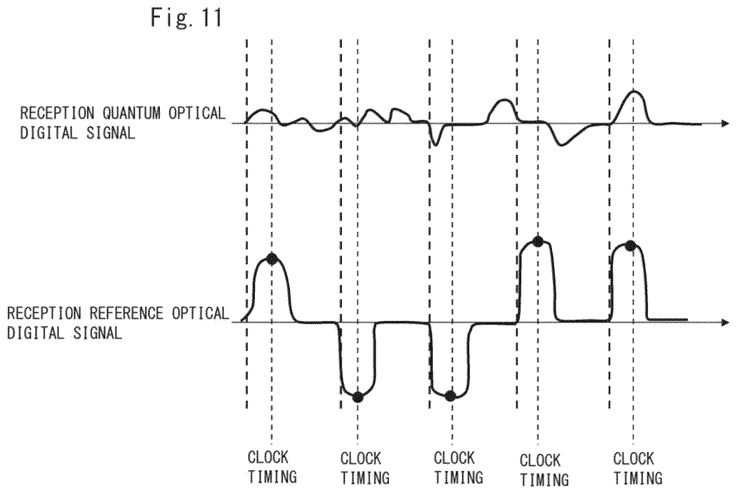

FIG. 11 illustrates a specific example of clock synchronization in the clock synchronization unit 234 according to some example embodiments. Since the quantum light received by the receiver 200 has very low intensity, it is difficult to extract the clock timing with the quantum light alone. Therefore, the quantum key distribution system 1 can accurately extract the clock timing by using the clock timing of the Y-polarized light component (reference light component) modulated in synchronization with the quantum light with high intensity among the optical signals before the polarization demodulation as a trigger. As illustrated in FIG. 11, for example, a high signal-to-noise ratio can be achieved in a reception digital signal of an optical signal in which reference light having high intensity different from an optical signal in which reference light is not polarization-multiplexed with quantum light and modulated in synchronization with the quantum light is polarization-multiplexed with quantum light. For example, the clock synchronization unit 234 extracts the center timing of the rectangular pulse as the clock timing from the reception digital signal of the reference light component (reception reference light digital signal) as illustrated in FIG. 11. The analog-to-digital converter 220 performs sampling with the clock timing extracted from the reception reference light digital signal as a sampling timing, and performs analog-to-digital conversion on the coherently detected signal.

Subsequently, the receiver 200 demodulates the polarization of the analog-to-digital converted signal (S108). The polarization demodulation unit 231 polarization-separates the analog-to-digital converted digital electric signal into X-polarization and Y-polarized signals. Specifically, the polarization demodulation unit 231 converts the I component digital electric signal of the X′ polarization, the Q component digital electric signal of the X′ polarization, the I component digital electric signal of the Y′ polarization, and the Q component digital electric signal of the Y′ polarization into X-polarization and Y-polarization signals, and generates the I component digital electric signal of the X-polarization after polarization separation, the Q component digital electric signal of the X-polarization (reception quantum optical signal), the I component digital electric signal of the Y-polarization, and the Q component digital electric signal of the Y-polarization (reception reference optical signal).

Subsequently, the receiver 200 demodulates the phase of the Y-polarized reference light subjected to the polarization demodulation (S109). The reference optical phase demodulation unit 232 demodulates (corrects) the phase of the Y-polarization digital electric signal (reception reference optical signal) subjected to the polarization demodulation. The reference optical phase demodulation unit 232 tracks the phase variation due to the frequency and phase difference between the light of the light source 110 of the transmitter 100 and the light of the light source 211 of the receiver 200 with respect to the reception reference optical signal, extracts the phase reference, and demodulates the original phase modulation value. For example, the reference optical phase demodulation unit 232 corrects the phase of the reference optical signal such that the constellation in an I-Q plane becomes a QPSK pattern.

Subsequently, the receiver 200 corrects the phase of the X-polarized quantum light subjected to the polarization demodulation (S110). The quantum optical phase correction unit 233 corrects the phase of the X-polarization digital electric signal (reception quantum optical signal) subjected to the polarization demodulation. The quantum optical phase correction unit 233 corrects the phase of the reception quantum optical signal by reflecting the phase correction value of the reception reference optical signal used in the phase correction by the reference optical phase demodulation unit 232 with respect to the reception quantum optical signal. The quantum optical phase correction unit 233 corrects a phase shift caused by a phase difference between the quantum light and the reference light with respect to the reception quantum optical signal after reflecting the phase correction value of the reception reference optical signal. The quantum optical phase correction unit 233 corrects the inclination of the constellation by disclosing a part of the data of the quantum optical signal reflecting the phase correction value of the reference optical signal via the classical channel. The quantum optical phase correction unit 233 corrects the phase of the quantum optical signal in such a way that the constellation has a QPSK pattern.

Subsequently, the receiver 200 reads the bits of the phase-corrected quantum light (S111). For example, the bit reading unit 235a receives the basis data from the transmitter 100 through the classical channel, rotates the phase of the phase-corrected quantum optical signal based on the received basis data, and generates a bit string of 0 or 1 (quantum optical bit string).

The receiver 200 reads the phase-demodulated bit of the reference light (S112). The bit reading unit 235b performs hard decision on the reception reference optical signal after the phase demodulation to generate a bit string (reference light bit string) of 0 or 1. For example, in the case of a QPSK signal, the bit reading unit 235 b reads any one of 00, 01, 10, and 11 based on the symbol position on the constellation.

Subsequently, the receiver 200 performs bit position synchronization (S113). The bit position synchronization unit 236 extracts data for bit position synchronization from the reference light bit string read from the reception reference optical signal after the phase demodulation, and outputs a start position of a random number indicated by the data for bit position synchronization. The shift key output unit 237 outputs, as a shift key, a bit string starting from a start position indicated by the data for bit position synchronization among the quantum optical bit strings read from the reception quantum optical signal after the phase correction.

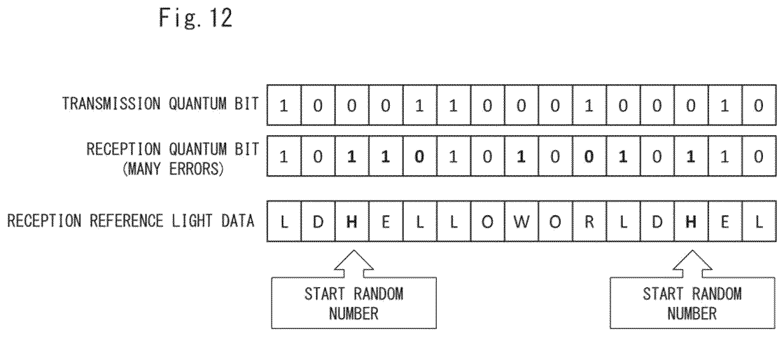

FIG. 12 illustrates a specific example of bit position synchronization in the bit position synchronization unit 236 according to some example embodiments. Since quantum light has weak intensity and a reception quantum bit (quantum light bit string) contains a large number of errors, it is difficult to perform bit position synchronization with a reception quantum bit alone. Therefore, in the quantum key distribution system 1, bit position synchronization is performed by data of modulated reference light having high intensity and modulated in synchronization with quantum light. For example, as illustrated in FIG. 12, the read reception reference light data (reference light bit string) includes repetition of “HELLOWORLD” which is data for bit position synchronization, and a first character “H” of “HELLOWORLD” indicates a start position of a random number. The bit position synchronization unit 236 outputs the timing of the start position of the random number, and the shift key output unit 237 outputs a bit string (for example, “1101010010”) starting from the start position as a shift key from the read reception quantum bit. Thereafter, error correction and confidentiality enhancement are performed on the shift key, and a quantum key is obtained. The error correction processing and the confidentiality enhancement processing may be performed by the QKD signal reception unit 201 or may be performed outside the QKD signal reception unit 201.

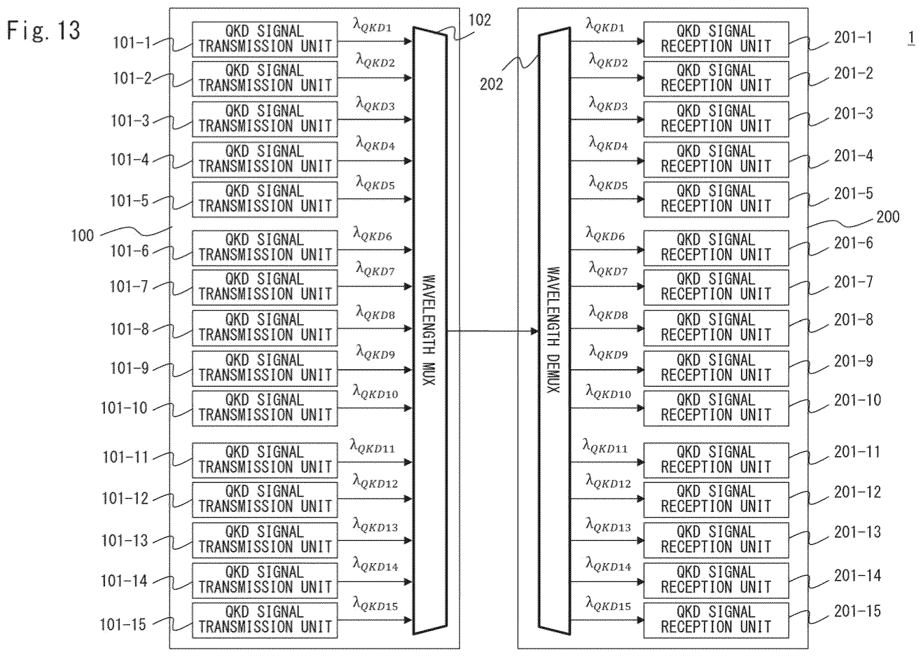

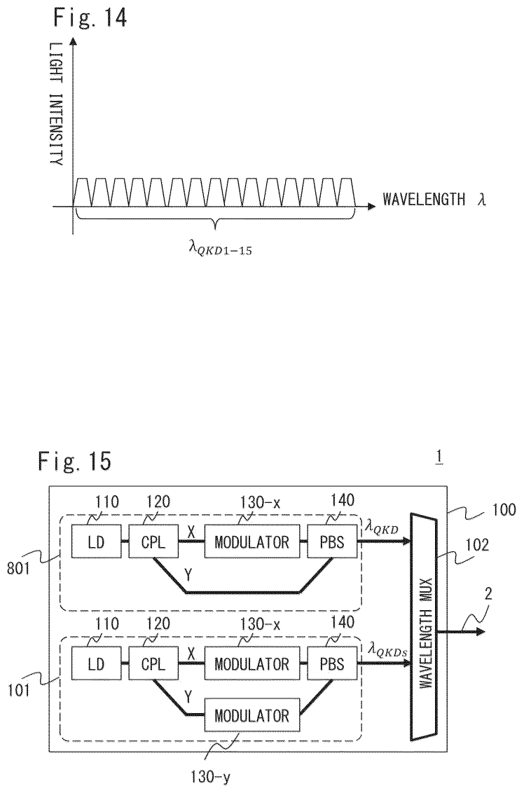

A wavelength configuration example in the quantum key distribution system 1 according to some example embodiments will be described with reference to FIGS. 13 and 14. In the example of FIG. 13, the transmitter 100 includes QKD signal transmission units 101-1 to 101-15 that respectively transmit QKD signals of wavelengths λ_{QKD1} to λ_{QKD15} including quantum light and reference light (for bit position synchronization). The wavelength multiplexing unit 102 performs wavelength multiplexing on the optical signals (QKD signals) having the wavelengths λ_{QKD1} to λ_{QKD15}. In the receiver 200, the wavelength separation unit 202 separates the wavelength-multiplexed optical signal into optical signals (QKD signals) of wavelengths λ_{QKD1} to λ_{QKD15}. The receiver 200 includes QKD signal reception units 201-1 to 201-15 that receive QKD signals of wavelengths λ_{QKD1} to λ_{QKD15}, respectively. In this case, as illustrated in FIG. 14, all the wavelengths λ_{QKD1} to λ_{QKD15} can be used for the QKD signal.

As described above, in the present example embodiment, bit position synchronization is enabled using reference light that is polarization-multiplexed in quantum light for phase demodulation in the basic example. That is, bit position synchronization is performed by modulating reference light to be subjected to polarization multiplexing and transmitting data for bit position synchronization. As a result, as illustrated in FIG. 14, another wavelength light of bit position synchronization is unnecessary, and the frequency utilization efficiency of the CV-QKD system can be improved. Since another wavelength light of bit position synchronization is unnecessary, for example, the configuration of the receiver optical system becomes simple.

### Third Example Embodiment

Next, a third example embodiment will be described. In the present example embodiment, an example in which bit position synchronization is performed at another QKD wavelength based on data for bit position synchronization transmitted at a QKD wavelength will be described. The present example embodiment is an example in which the basic example and the second example embodiment are combined, and each configuration described in the basic example and each configuration described in the second example embodiment may be appropriately used.

FIG. 15 illustrates an example configuration of a transmitter 100 according to some example embodiments. In the example of FIG. 15, the transmitter 100 includes a QKD signal transmission unit 801 of a basic example, a QKD signal transmission unit 101 of the second example embodiment, and a wavelength multiplexing unit (MUX) 102. A configuration of the QKD signal transmission unit 801 is similar to that in FIG. 1. A configuration of the QKD signal transmission unit 101 is similar to that in FIG. 8. For example, in the QKD signal transmission unit 101, a light source 110 may be referred to as a first light source, an optical coupler 120 may be referred to as a first splitting unit, a modulator 130-x may be referred to as a first modulation unit, a modulator 130-y may be referred to as a second modulation unit, and a polarizing beam splitter 140 may be referred to as a first polarization multiplexing unit. For example, in the QKD signal transmission unit 801, the light source 110 may be referred to as a second light source, the optical coupler 120 may be referred to as a second splitting unit, the modulator 130-x may be referred to as a third modulation unit, and the polarizing beam splitter 140 may be referred to as a second polarization multiplexing unit. The transmitter 100 may include a plurality of QKD signal transmission units 801 and a plurality of QKD signal transmission units 101 that transmit QKD signals of different wavelengths. Here, a wavelength of the QKD signal generated by the QKD signal transmission unit 101 is referred to as λ_{QKDs}.

For example, the transmission of the random number by the QKD signal transmission unit 801 and the transmission of the data for bit position synchronization by the QKD signal transmission unit 101 are synchronized with each other. Specifically, modulation using a random number by the modulator 130-x of the QKD signal transmission unit 801 and modulation using data for bit position synchronization by the modulator 130-y of the QKD signal transmission unit 101 are synchronized.

The wavelength multiplexing unit 102 performs wavelength multiplexing on the QKD signal having the wavelength λ_{QKD} generated by the QKD signal transmission unit 801 and the QKD signal having the wavelength λ_{QKDs} generated by the QKD signal transmission unit 101.

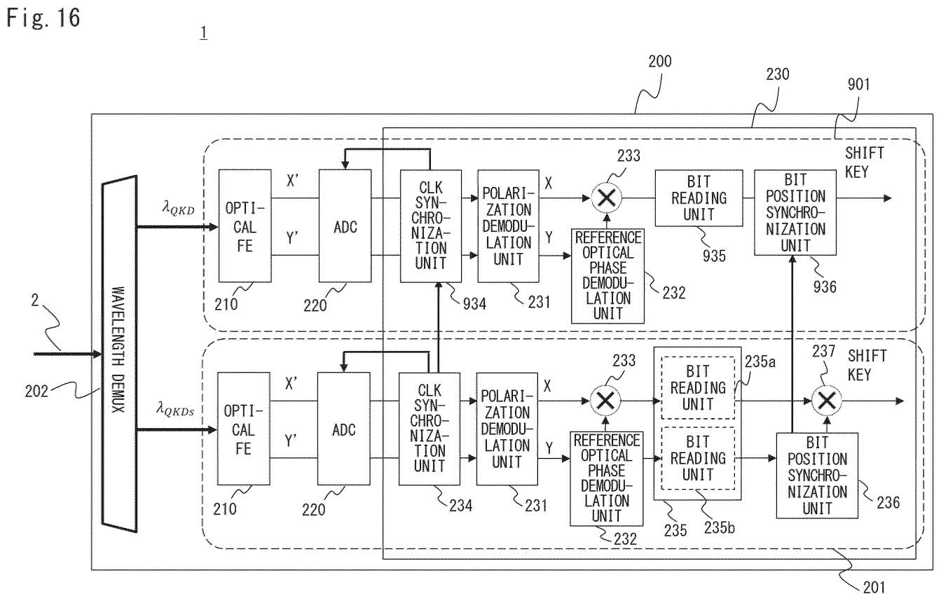

FIG. 16 illustrates an example configuration of a receiver 200 according to some example embodiments. In the example in FIG. 16, the receiver 200 includes a QKD signal reception unit 901 in the basic example, a QKD signal reception unit 201 in the second example embodiment, and a wavelength separation unit (DEMUX) 202. A configuration of the QKD signal reception unit 901 is similar to that in FIG. 1. A configuration of the QKD signal reception unit 201 is similar to that in FIG. 8. For example, in the QKD signal reception unit 201, the optical front end 210 may be referred to as a first photoelectric conversion unit, the analog-to-digital converter 220 may be referred to as a first analog-to-digital conversion unit, the clock synchronization unit 234 may be referred to as a first clock synchronization unit, the polarization demodulation unit 231 may be referred to as a first polarization demodulation unit, the reference optical phase demodulation unit 232 and the quantum optical phase correction unit 233 may be referred to as a first phase demodulation unit, the bit reading unit 235a may be referred to as a first bit reading unit, the bit reading unit 235b may be referred to as a second bit reading unit, and the bit position synchronization unit 236 may be referred to as a first bit position synchronization unit. For example, in the QKD signal reception unit 901, the optical front end 210 may be referred to as a second photoelectric conversion unit, the analog-to-digital converter 220 may be referred to as a second analog-to-digital conversion unit, the clock synchronization unit 934 may be referred to as a second clock synchronization unit, the polarization demodulation unit 231 may be referred to as a second polarization demodulation unit, the reference optical phase demodulation unit 232 and the quantum optical phase correction unit 233 may be referred to as a second phase demodulation unit, the bit reading unit 935 may be referred to as a third bit reading unit, and the bit position synchronization unit 936 may be referred to as a second bit position synchronization unit.

The wavelength separation unit 202 separates the QKD signal having the wavelength λ_{QKD} and the QKD signal having the wavelength λ_{QKDs} from the received wavelength-multiplexed signal light.

The QKD signal reception unit 901 performs clock synchronization and bit position synchronization based on the timing of clock synchronization and bit position synchronization extracted by the QKD signal reception unit 201. Skew adjustment may be performed on the timing of clock synchronization and bit position synchronization of the QKD signal reception unit 201.

The clock synchronization unit 234 of the QKD signal reception unit 201 extracts a clock timing based on the analog-to-digital converted digital electric signal of the Y polarized light component (reference light component) of the optical signal before polarization demodulation, and outputs the extracted clock timing to the clock synchronization unit 934 of the QKD signal reception unit 901. The clock synchronization unit 934 outputs the clock timing extracted by the clock synchronization unit 234 to the analog-to-digital converter 220.

The bit position synchronization unit 236 of the QKD signal reception unit 201 outputs the start position of the random number indicated by the data for bit position synchronization in the reference optical bit string read from the reception reference optical signal after the phase demodulation to the bit position synchronization unit 936 of the QKD signal reception unit 901. The bit position synchronization unit 936 outputs a bit string starting from the start position extracted by the bit position synchronization unit 236 as a random number sequence.

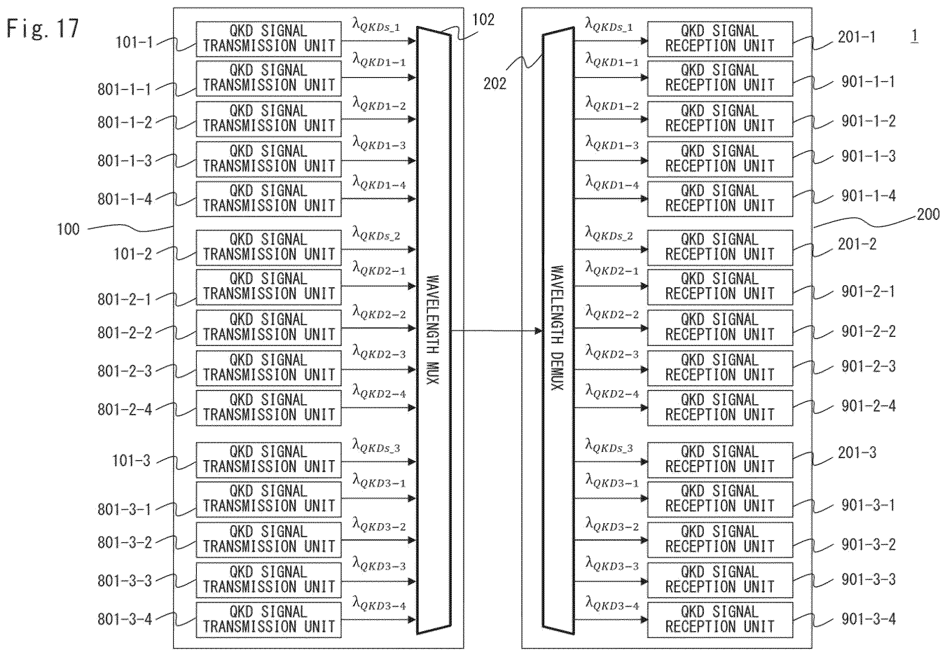

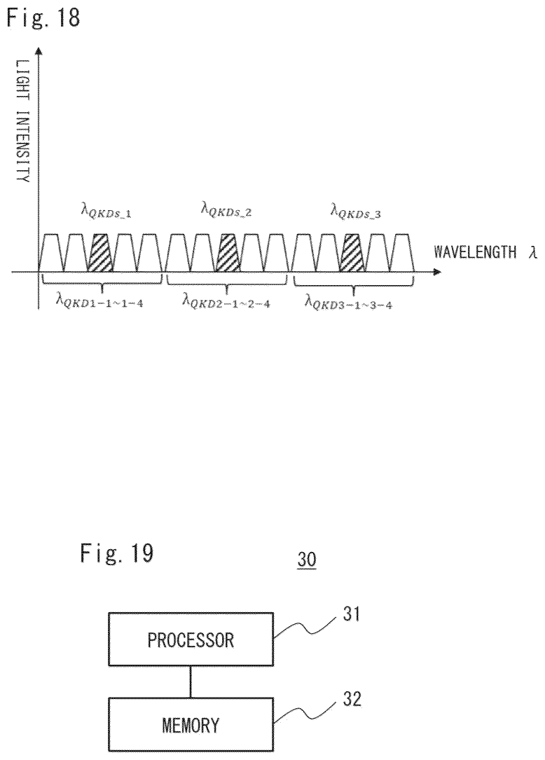

A wavelength configuration example in the quantum key distribution system 1 according to some example embodiments will be described with reference to FIGS. 17 and 18. In the examples of FIGS. 17 and 18, similarly to FIGS. 4 and 5, the QKD signals of four wavelengths λ_{QKD} are synchronized using the QKD signal of one wavelength λ_{QKDs}.

In the example of FIG. 17, the transmitter 100 includes a QKD signal transmission unit 101-1 that transmits a QKD signal of a wavelength λ_{QKDs_1}, QKD signal transmission units 801-1-1 to 801-1-4 that transmit QKD signals of wavelengths λ_{QKD1-1} to λ_{QKD1-4} synchronized with the QKD signal of the wavelength λ_{QKDs_1}, a QKD signal transmission unit 101-2 that transmits a QKD signal of a wavelength λ_{QKDs_2}, QKD signal transmission units 801-2-1 to 801-2-4 that transmit QKD signals of wavelengths λ_{QKD2-1} to λ_{QKD2-4} synchronized with the QKD signal of the wavelength λ_{QKDs_2}, and a QKD signal transmission unit 101-3 that transmits a QKD signal of a wavelength λ_{QKDs_3}, and QKD signal transmission units 801-3-1 to 801-3-4 that transmit QKD signals of wavelengths λ_{QKD3-1} to λ_{QKD3-4} synchronized with the QKD signal of the wavelength λ_{QKDs_3}, respectively.

The wavelength multiplexing unit 102 performs wavelength multiplexing on the optical signals (QKD signals) of the wavelengths λ_{QKDs_1}, λ_{QKDs_2}, λ_{QKDs_3}, λ_{QKD1-1} to λ_{QKD1-4}, λ_{QKD2-1} to λ_{QKD2-4}, and λ_{QKD3-1} to λ_{QKD3-4}.

In the receiver 200, the wavelength separation unit 202 separates the wavelength-multiplexed optical signal into optical signals (QKD signals) of wavelengths λ_{QKDs_1}, λ_{QKDs_2}, λ_{QKDs_3}, λ_{QKD1-1} to λ_{QKD1-4}, λ_{QKD2-1} to λ_{QKD2-4}, and λ_{QKD3-1} to λ_{QKD3-4}.

The receiver 200 includes a QKD signal reception unit 201-1 that receives a QKD signal of a wavelength λ_{QKDs_1}, QKD signal reception units 901-1-1 to 901-1-4 that receive QKD signals of wavelengths λ_{QKD1-1} to λ_{QKD1-4} synchronized with the QKD signal of the wavelength λ_{QKDs_1}, a QKD signal reception unit 201-2 that receives a QKD signal of a wavelength λ_{QKDs_2}, QKD signal reception units 901-2-1 to 901-2-4 that receive QKD signals of wavelengths λ_{QKD2-1} to λ_{QKD2-4} synchronized with the QKD signal of the wavelength λ_{QKDs_2}, a synchronization signal reception unit 902-3 that receives a QKD signal of a wavelength λ_{QKDs_3}, QKD signal reception units 901-3-1 to 901-3-4 that receive QKD signals of wavelengths λ_{QKD3-1} to λ_{QKD3-4} synchronized with the QKD signal of the wavelength λ_{QKDs_3}, respectively.

In this case, as illustrated in FIG. 18, one of the five wavelengths is used for a QKD signal that transmits data for bit position synchronization. For example, a center wavelength of the wavelengths λ_{QKD1-1} to λ_{QKD1-4} is set as a wavelength λ_{QKDs_1} for transmitting data for bit position synchronization. The wavelengths λ_{QKD1-1} to λ_{QKD1-4} and the wavelength λ_{QKDs_} are adjacent to each other. A center wavelength of the wavelengths λ_{QKD2-1} to λ_{QKD2-4} is set as a wavelength λ_{QKDs_2} for transmitting data for bit position synchronization. The wavelengths λQKD₂₋₁ to λ_{QKD2-4} and the wavelength λ_{QKDs_2} are adjacent to each other. A center wavelength of the wavelengths λ_{QKD3-1} to λ_{QKD3-4} is set as a wavelength λ_{QKDs_3} for transmitting data for bit position synchronization. The wavelengths λ_{QKD3-1} to λ_{QKD3-4} and the wavelength λ_{QKDs_3} are adjacent to each other.

In this manner, bit position synchronization may be performed at another QKD wavelength based on the data for bit position synchronization transmitted at the QKD wavelength. Even in this case, the frequency utilization efficiency can be improved similarly to the second example embodiment. The device configuration can be further simplified.

The present disclosure is not limited to the above example embodiments, and can be appropriately changed without departing from the scope.

Each configuration in the above-described example embodiments may be implemented by hardware, software, or both, and may be implemented by one piece of hardware or software or by a plurality of pieces of hardware or software. Each function of each device (transmitter, receiver, etc.) (processing of a digital signal processor and the like) may be achieved by a computer 30 including a processor 31 such as a central processing unit (CPU) and a memory 32 which is a storage device as illustrated in FIG. 19. For example, a program for performing the method of the example embodiment may be stored in the memory 32, and each of the functions may be achieved by executing the program stored in the memory 32 by the processor 31.

These programs include a group of commands (or software codes) causing a computer to perform one or more of the functions described in the example embodiments in a case of being read by the computer. The program may be stored in a non-transitory computer readable medium or a tangible storage medium. As an example and not by way of limitation, the computer-readable medium or the tangible storage medium includes a random access memory (RAM), a read only memory (ROM), a flash memory, a solid-state drive (SSD) or any other memory technique, a CD-ROM, a digital versatile disc (DVD), a Blu-ray (registered trademark) disc or any other optical disk storage, a magnetic cassette, a magnetic tape, a magnetic disk storage, and any other magnetic storage device. The program may be transmitted through a transitory computer-readable medium or a communication medium. By way of example, and not limitation, transitory computer-readable or communication media include electrical, optical, acoustic, or other forms of propagated signals.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

Each of the drawings is merely an example to illustrate one or more example embodiments. Each drawing is not associated with only one specific example embodiment, but may be associated with one or more other example embodiments. As those of ordinary skill in the art will appreciate, various features or steps described with reference to any one of the drawings may be combined with features or steps illustrated in one or more other drawings, for example, to create an example embodiment that is not explicitly illustrated or described. All of the features or the steps illustrated in any one of the drawings illustrating illustrative example embodiments are not necessarily mandatory, and some features or steps may be omitted. The order of the steps described in any of the figures may be changed as appropriate.

Some or all of the above-described example embodiments may be described as the following supplementary notes, but are not limited to the following supplementary notes.

### Supplementary Note 1

A transmitter including:
a first light source that outputs first light;
a first splitting unit that splits the first light into first polarized light of a first polarization and second polarized light of a second polarization;
a first modulation unit that modulates the first polarized light based on a first random number;
a second modulation unit that modulates the second polarized light based on data for bit position synchronization of the first random number; and
a first polarization multiplexing unit that polarization-multiplexes the modulated first polarized light and the modulated second polarized light and transmits the polarization-multiplexed first polarization-multiplexed light to a receiver.

### Supplementary Note 2

The transmitter according to Supplementary Note 1, in which the data for bit position synchronization indicates a start position of the first random number.

### Supplementary Note 3

The transmitter according to Supplementary Note 1 or 2, in which the modulated second polarized light indicates a clock timing for transmitting the modulated first polarized light.

### Supplementary Note 4

The transmitter according to Supplementary Note 1 or 2, in which the modulated second polarized light is reference light for phase demodulation of the modulated first polarized light.

### Supplementary Note 5

The transmitter according to Supplementary Note 1 or 2, further including a wavelength multiplexer that wavelength-multiplexes the first polarization-multiplexed light and transmits the wavelength-multiplexed light to the receiver.

### Supplementary Note 6

The transmitter according to Supplementary Note 5, further including:
a second light source that outputs second light;
a second splitting unit that splits the second light into third polarized light of the first polarization and fourth polarized light of the second polarization;
a third modulation unit that modulates the third polarized light based on a second random number; and
a second polarization multiplexing unit that polarization-multiplexes the modulated third polarized light and the fourth polarized light to generate second polarization-multiplexed light,
in which the wavelength multiplexer wavelength-multiplexes the first polarization-multiplexed light and the second polarization-multiplexed light, and transmits the wavelength-multiplexed light to the receiver.

### Supplementary Note 7

A receiver including:
a first photoelectric conversion unit that receives first polarization-multiplexed light from a transmitter and converts the received first polarization-multiplexed light into a first electric signal;
a first polarization demodulation unit that polarization-demodulates the first electric signal into a first polarized signal of a first polarization and a second polarized signal of a second polarization;
a first bit reading unit that reads a first bit string including a first random number from the first polarized signal;
a second bit reading unit that reads a second bit string including data for bit position synchronization of the first random number from the second polarized signal; and
a first bit position synchronization unit that performs bit position synchronization of the first random number included in the first bit string based on the data for bit position synchronization included in the second bit string.

### Supplementary Note 8

The receiver according to Supplementary Note 7, in which the bit position synchronization unit performs bit position synchronization of the first random number based on a start position of the first random number indicated by the data for bit position synchronization.

### Supplementary Note 9

The receiver according to Supplementary Note 7 or 8, further including:
a first analog-to-digital conversion unit that analog-to-digital converts the first electric signal and generates a first digital signal; and
a first clock synchronization unit that extracts a clock timing based on the first digital signal,
in which the first analog-to-digital conversion unit performs the analog-to-digital conversion based on the extracted clock timing.

### Supplementary Note 10

The receiver according to Supplementary Note 7 or 8, further including a first phase demodulation unit that demodulates a phase of the second polarized signal and demodulates a phase of the first polarized signal based on the demodulated phase.

### Supplementary Note 11

The receiver according to Supplementary Note 7 or 8, further including a wavelength separation unit that receives wavelength-multiplexed light from the transmitter and wavelength-separates the first polarization-multiplexed light from the received wavelength-multiplexed light.

### Supplementary Note 12

The receiver according to Supplementary Note 11, in which
the wavelength separation unit wavelength-separates the first polarization-multiplexed light and the second polarization-multiplexed light from the received wavelength-multiplexed light, and
the receiver further includes:
a second photoelectric conversion unit that converts the second polarization-multiplexed light into a second electric signal;
a second polarization demodulation unit that polarization-demodulates the second electric signal into a third polarized signal of the first polarization and a fourth polarized signal of the second polarization;
a third bit reading unit that reads a third bit string including a second random number from the third polarized signal; and
a second bit position synchronization unit that performs bit position synchronization of the second random number included in the third bit string based on the data for bit position synchronization included in the second bit string.

### Supplementary Note 13

A quantum key distribution system including a transmitter and a receiver, in which the transmitter includes:
a first light source that outputs first light;
a first splitting unit that splits the first light into first polarized light of a first polarization and second polarized light of a second polarization;
a first modulation unit modulates the first polarized light based on a first random number;
a second modulation unit that modulates the second polarized light based on data for bit position synchronization of the first random number; and
a first polarization multiplexing unit that polarization-multiplexes the modulated first polarized light and the modulated second polarized light and transmits the polarization-multiplexed first polarization-multiplexed light to a receiver, and
the receiver includes:
a first photoelectric conversion unit that receives the first polarization-multiplexed light from the transmitter and converts the received first polarization-multiplexed light into a first electric signal;
a first polarization demodulation unit that polarization-demodulates the first electric signal into a first polarized signal of a first polarization and a second polarized signal of a second polarization;
a first bit reading unit that reads a first bit string including the first random number from the first polarized signal;
a second bit reading unit that reads, from the second polarized signal, a second bit string including the data for bit position synchronization of the first random number; and
a first bit position synchronization unit that performs bit position synchronization of the first random number included in the first bit string based on the data for bit position synchronization included in the second bit string.

### Supplementary Note 14

A method in a transmitter including:
splitting first light from a first light source into first polarized light of a first polarization and second polarized light of a second polarization;
modulating the first polarized light based on a first random number;
modulating the second polarized light based on data for bit position synchronization of the first random number; and
polarization-multiplexing the modulated first polarized light and the modulated second polarized light and transmitting the polarization-multiplexed first polarization-multiplexed light to a receiver.

### Supplementary Note 15

A method in a receiver including:
receiving first polarization-multiplexed light from a transmitter and converting the received first polarization-multiplexed light into a first electric signal;
polarization-demodulating the first electric signal into a first polarized signal of a first polarization and a second polarized signal of a second polarization;
reading a first bit string including a first random number from the first polarized signal;
reading a second bit string including data for bit position synchronization of the first random number from the second polarized signal; and
performing bit position synchronization of the first random number included in the first bit string based on the data for bit position synchronization included in the second bit string.

### Supplementary Note 16

A program causing a computer to execute a method in a transmitter including:
splitting first light from a first light source into first polarized light of a first polarization and second polarized light of a second polarization;
modulating the first polarized light based on a first random number;
modulating the second polarized light based on data for bit position synchronization of the first random number; and
polarization-multiplexing the modulated first polarized light and the modulated second polarized light and transmitting the polarization-multiplexed first polarization-multiplexed light to a receiver.

### Supplementary Note 17

A program causing a computer to execute a method in a receiver including:
receiving first polarization-multiplexed light from a transmitter and converting the received first polarization-multiplexed light into a first electric signal;
polarization-demodulating the first electric signal into a first polarized signal of a first polarization and a second polarized signal of a second polarization;
reading a first bit string including a first random number from the first polarized signal;
reading a second bit string including data for bit position synchronization of the first random number from the second polarized signal; and
performing bit position synchronization of the first random number included in the first bit string based on the data for bit position synchronization included in the second bit string.

Some or all of the elements (for example, configurations and functions) described in Supplementary Notes 2 to 6 and Supplementary Notes 8 to 12 dependent on Supplementary Note 1 (transmitter) and Supplementary Note 7 (receiver) can also be dependent on Supplementary Note 13 (quantum key distribution system), Supplementary Notes 14 and 15 (method), and Supplementary Notes 16 and 17 (program) by the same dependency relationship as Supplementary Notes 2 to 6 and Supplementary Notes 8 to 12. Some or all of the elements described in any Supplementary Note may be applied to various types of hardware, software, recording means for recording software, systems, and methods.

What is claimed is:

1. A transmitter comprising:
a first light source that outputs first light;
a first splitter that splits the first light into first polarized light of a first polarization and second polarized light of a second polarization;
a first modulator that modulates the first polarized light based on a first random number;
a second modulator that modulates the second polarized light based on data for bit position synchronization of the first random number; and
a first polarization multiplexer that polarization-multiplexes the modulated first polarized light and the modulated second polarized light and transmits the polarization-multiplexed first polarization-multiplexed light to a receiver.

2. The transmitter according to claim 1, wherein the data for bit position synchronization indicates a start position of the first random number.

3. The transmitter according to claim 1, wherein the modulated second polarized light indicates a clock timing for transmitting the modulated first polarized light.

4. The transmitter according to claim 1, wherein the modulated second polarized light is reference light for phase demodulation of the modulated first polarized light.

5. The transmitter according to claim 1, further comprising a wavelength multiplexer that wavelength-multiplexes the first polarization-multiplexed light and transmits the wavelength-multiplexed light to the receiver.

6. The transmitter according to claim 5, further comprising:
a second light source that outputs second light;
a second splitter that splits the second light into third polarized light of the first polarization and fourth polarized light of the second polarization;
a third modulator that modulates the third polarized light based on a second random number; and
a second polarization multiplexer that polarization-multiplexes the modulated third polarized light and the fourth polarized light to generate second polarization-multiplexed light,
wherein the wavelength multiplexer wavelength-multiplexes the first polarization-multiplexed light and the second polarization-multiplexed light, and transmits the wavelength-multiplexed light to the receiver.

7. A receiver comprising:
a first photoelectric converter that receives first polarization-multiplexed light from a transmitter and converts the received first polarization-multiplexed light into a first electric signal;
a first polarization demodulator that polarization-demodulates the first electric signal into a first polarized signal of a first polarization and a second polarized signal of a second polarization;
a first bit reader that reads a first bit string including a first random number from the first polarized signal;
a second bit reader that reads a second bit string including data for bit position synchronization of the first random number from the second polarized signal; and
a first bit position synchronizer that performs bit position synchronization of the first random number included in the first bit string based on the data for bit position synchronization included in the second bit string.

8. The receiver according to claim 7, wherein the bit position synchronizer performs bit position synchronization of the first random number based on a start position of the first random number indicated by the data for bit position synchronization.

9. The receiver according to claim 7, further comprising:
a first analog-to-digital converter that analog-to-digital converts the first electric signal and generates a first digital signal; and
a first clock synchronizer that extracts a clock timing based on the first digital signal,
wherein the first analog-to-digital converter performs the analog-to-digital conversion based on the extracted clock timing.

10. The receiver according to claim 7, further comprising a first phase demodulator that demodulates a phase of the second polarized signal and demodulates a phase of the first polarized signal based on the demodulated phase.

11. The receiver according to claim 7, further comprising a wavelength separator that receives wavelength-multiplexed light from the transmitter and wavelength-separates the first polarization-multiplexed light from the received wavelength-multiplexed light.

12. The receiver according to claim 11, wherein
the wavelength separator wavelength-separates the first polarization-multiplexed light and the second polarization-multiplexed light from the received wavelength-multiplexed light, and
the receiver further comprises:
a second photoelectric converter that converts the second polarization-multiplexed light into a second electric signal;
a second polarization demodulator that polarization-demodulates the second electric signal into a third polarized signal of the first polarization and a fourth polarized signal of the second polarization;
a third bit reader that reads a third bit string including a second random number from the third polarized signal; and
a second bit position synchronizer that performs bit position synchronization of the second random number included in the third bit string based on the data for bit position synchronization included in the second bit string.

13. A quantum key distribution system comprising a transmitter and a receiver, wherein
the transmitter includes:
a first light source that outputs first light;
a first splitter that splits the first light into first polarized light of a first polarization and second polarized light of a second polarization;
a first modulator that modulates the first polarized light based on a first random number;
a second modulator that modulates the second polarized light based on data for bit position synchronization of the first random number; and
a first polarization multiplexer that polarization-multiplexes the modulated first polarized light and the modulated second polarized light and transmits the polarization-multiplexed first polarization-multiplexed light to a receiver, and
the receiver includes:
a first photoelectric converter that receives the first polarization-multiplexed light from the transmitter and converts the received first polarization-multiplexed light into a first electric signal;
a first polarization demodulator that polarization-demodulates the first electric signal into a first polarized signal of a first polarization and a second polarized signal of a second polarization;
a first bit reader that reads a first bit string including the first random number from the first polarized signal;
a second bit reader that reads, from the second polarized signal, a second bit string including the data for bit position synchronization of the first random number; and
a first bit position synchronizer that performs bit position synchronization of the first random number included in the first bit string based on the data for bit position synchronization included in the second bit string.
